(19) United States
(12) Patent Application Publication
(10) Pub. No.: US 2002/0194726 A1
(43) Pub. Date: Dec. 26, 2002

(54) Mold structure of an extrusion tool for extruding and sealing a connector

(76) Inventor: Chi-Fu Chang, Taipei (TW)

Correspondence Address: DOUGHERTY & TROXELL, 5205 Leesburg Pike, Suite 1404, Falls Church, VA, 22041, US

(21) Appl. No.: 09/887,075

(22) Filed: Jun. 25, 2001

(51) Int. Cl. B23P 19/00; H01R 43/042; H01R 43/00

(52) U.S. Cl. 29/751; 29/748; 29/828

(57) ABSTRACT

A mold structure of an extrusion tool for extruding and sealing a connector is disclosed. The mold structure is capable of being inserted into a mold supporting seat for receiving a coaxial cable; the mold structure clamping the coaxial cable. The mold structure has the following components. A seat is installed with a hole for receiving a coaxial cable. A chuck passes through the seat so that the chuck can move toward or leave away from the coaxial cable along an axial direction. A movable element is installed at one side of the seat for control an extent of movement of the chuck moving toward the coaxial cable along an axial direction. Thereby, the chuck moves toward or leaves from the axial direction; and the coaxial cable is clamped and fixed by a sufficient force.

### FIELD OF THE INVENTION

The present invention relates to a mold structure of an extrusion tool for extruding and sealing a connector, wherein a movable element controls the extent of movement of a chuck moving toward a coaxial cable along an axial direction. Thereby, the chuck moves toward or leaves from the axial direction; and the coaxial cable is clamped and fixed by a sufficient force.

### BACKGROUND OF THE INVENTION

The coaxial cable connector is well known in the art. Typically, an F-type coaxial cable connector is threaded onto a complimentary interface connector to integrate the coaxial cables with various electronic devices, such as televisions, CB (Citizens Band) radios, FM (Frequency Modulation) radios, and wireless amateur radio systems into one unit.

The conventional coaxial cable includes a central conductor, a dielectric insulator covered on the central conductor, at least one layer of braided shield body disposed around the periphery of the dielectric insulator, and an outer cover shielded on top of the at least one layer of braided shield body. The conventional coaxial connector includes a joint body and an insertion component. The compressing and connection of the insertion component to the outer jacket cylinder of the joint body makes the outer jacket cylinder compress inwardly and deform to tightly conjoin with the coaxial cable. Since the soft materials of polyvinyl chloride used for the outer cover of the coaxial cable has been replaced by the stiff polyethylene materials, the free end of the polyethylene coaxial cable can not force the outer cover onto the coaxial connector to form connection through manual operation, but must be inserted to the coaxial connector by press-in tool. Then the insertion component will be compressed onto the outer jacket cylinder of the joint body by using the compressing tool to make one end of the coaxial connector shrink and conjoin with the stiff-jacketed cable. Therefore, this kind of operation requires extra cost, multiple installation tools, causes the inconvenience of carrying extra tools and needs to be improved.

The inventor of the present invention has disclosed an extrusion tool, such as that disclosed in U.S. Ser. No. 09/836294, in that an extrusion tool for extruding and sealing a coaxial connector is disclosed. The mold supporting end of the extrusion tool has an extractable mold structure for suiting to various coaxial cables. By the mold structure, the hard skin of the coaxial cable can be clamped and fixed for extrusion.

As shown in FIG. 1, a mold structure for used in a PE coaxial cable is illustrated. The mold structure has two molds A and B and a buckle C. By the buckle C, the hard skin of the coaxial cable is clamped and fixed. However, many parts are necessary in this clamping way and thus the manufacturing cost is high. Besides, in the processes of extruding combining and taking out a product, many operating steps are required. Therefore, the overall operation procedures are complex.

### SUMMARY OF THE INVENTION

Accordingly, the primary object of the present invention is to provide a mold structure of an extrusion tool for extruding and sealing a connector, wherein a chuck cause a cavity surface to engage the hard skin of the coaxial cable so that the distal joint and engaging element are extruded and combined between the push rod and the mold structure, thereby, one end of the distal joint F is reduced and connected to the coaxial cable.

To achieve above objects, the present invention provides mold structure of an extrusion tool for extruding and sealing a connector. The mold structure is capable of being inserted into a mold supporting seat for receiving a coaxial cable. The mold structure has the following components. A seat is installed with a hole for receiving a coaxial cable. A chuck passes through the seat so that the chuck can move toward or leave away from the coaxial cable along an axial direction. A movable element is installed at one side of the seat for control an extent of movement of the chuck moving toward the coaxial cable along an axial direction. Thereby, the chuck moves toward or leaves from the axial direction; and the coaxial cable is clamped and fixed by a sufficient force.

The various objects and advantages of the present invention will be more readily understood from the following detailed description when read in conjunction with the appended drawing.

### BRIEF DESCRIPTION OF THE DRAWINGS

FIG. 1 is a perspective view of a prior art mold structure.

FIG. 2 is a perspective view of the mold structure according to the present invention.

FIG. 3 is an exploded perspective view of the mold structure according to the present invention.

FIG. 4 is a cross sectional view of the mold structure of the present invention, in which the mold structure is at an opening position.

FIG. 5 is a cross sectional view of the mold structure of the present invention, in which the mold structure is at a closing position.

FIG. 6 is a perspective view showing that the mold structure of the present invention is assembly on an extrusion tool.

### DETAILED DESCRIPTION OF THE PREFERRED EMBODIMENTS

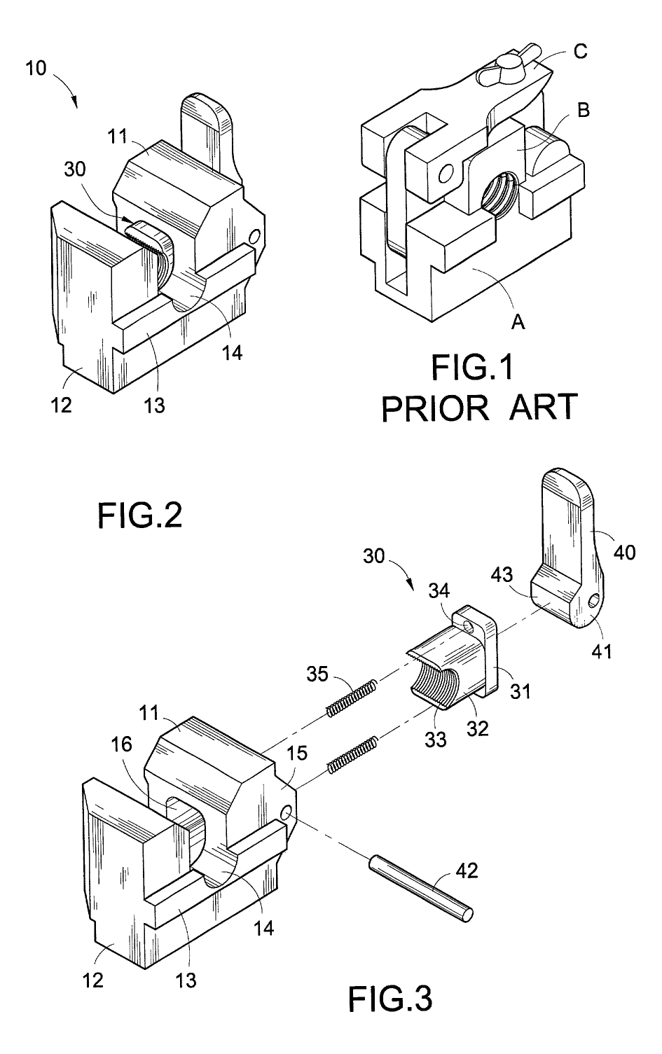

Referring to FIGS. 2, 3, and 6, the mold structure 10 of an extrusion tool for extruding and sealing a connector according to the present invention may be inserted to a mold supporting seat 21 of an extrusion tool 20. The mold supporting seat 21 is positioned at one end of a machine body 22.

The machine body 22 is installed with a seat 11 and a chuck 30. The seat 11 is installed with a protrusion 12 and a buckling block 13. The mold supporting seat 21 is installed with respective sliding groove 23 and recess 24 so that the mold structure 10 is inserted above the mold supporting seat 21. The protrusion 12 and buckling block 13 are arranged in the sliding groove 23 and recess 24 so that the two are matched properly.

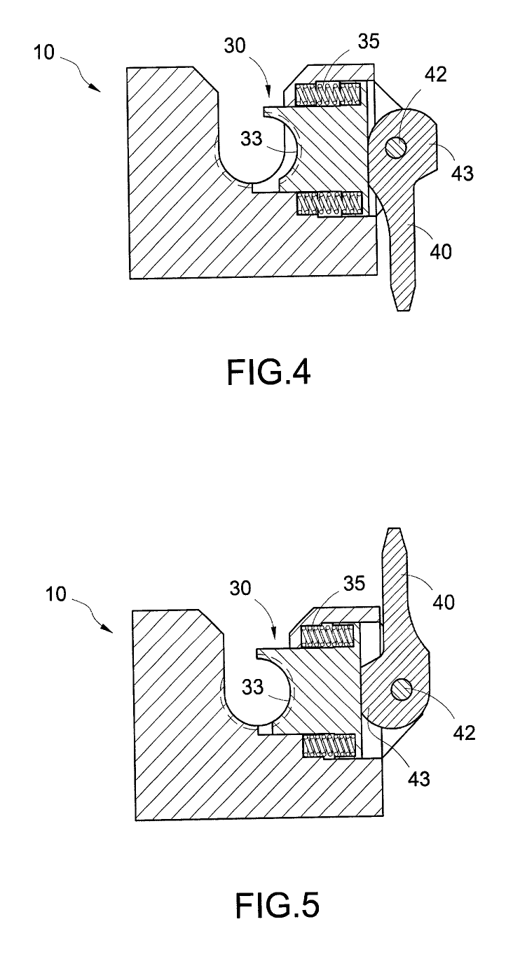

The seat 11 has an opening 25 which is communicated tot he hole 14 for receiving coaxial cable. The opening 25 is positioned at one end of the machine body 22. The chuck 30 is slidable in the hole 16 of the supporting end 15. The mold supporting end 15 is installed at one side of the seat 11. A movable element 40 is installed at the supporting end 15. One end 41 of the movable element 40 is firmly secured to one end of the supporting end 15. The movable element 40 is installed above the supporting end 15 by a supporting shaft 42 and the shaft 42 is utilized as a rotating center. The end 41 of the movable element 40 is installed with a shift flange 43 at the front end thereof which may adhere to or separate from the chuck 30 so that the chuck 30 moves along the positions illustrated in FIGS. 4 and 5.

The chuck 30 has a base portion 31 on which a clamping portion 32 is installed. The clamping portion 32 has a cavity surface 33 having a slightly semicircle shape. The cavity surface 33 is a threaded surface for being engaged to the hard skin of a coaxial cable, thereby, assuring that the hard skin of the coaxial cable is firmly secured.

The base portion 31 is installed with two holes 34 each being installed with a spring 35. Thereby, the movable element 40 can be moved to push the chuck 30 to move forwards so as to proper match the hard skin of the coaxial cable and a proper gap is installed therebetween. Then the spring 35 is extruded to be in a compressing condition.

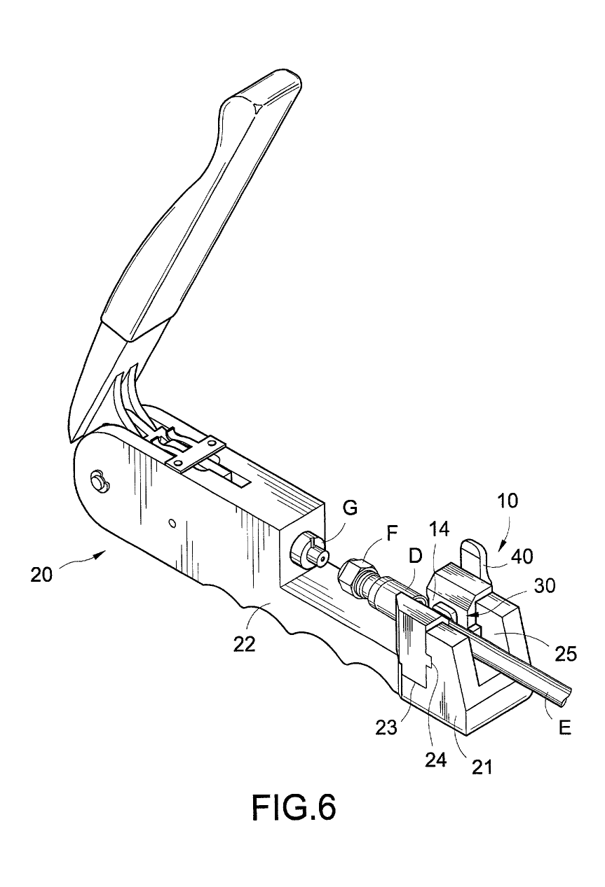

Referring to FIGS. 4 and 6, the extruding and combining steps of the distal joint and engaging element are illustrated. At first, the engaging element D is engaged with the coaxial cable. One end of the coaxial cable E is inserted into the distal joint F and then passes through hole 14 of the mold structure 10. The movable element 40 is moved upwards (referring to FIG. 5) around the supporting shaft 42 (referring to FIG. 4) so that the shift flange 43 of the movable element 40 moves the chuck 30 forwards around the center of the supporting shaft 42 with an eccentric distance. Then the spring 35 is extruded to be in a compressed condition. However, the forward moving chuck 30 cause the cavity surface 33 to engage the hard skin of the coaxial cable E so that the distal joint E and engaging element D are extruded and combined between the push rod G and the mold structure 10, thereby, one end of the distal joint F is reduced and connected to the coaxial cable E.

On the contrary, if a product is desired to be taken out, the movable element 40 is moved downwards so that the chuck 30 is not confined by the shift flange 43. By the elastic force of the spring 35, the chuck 30 moves from the coaxial cable E along an axial direction to reduce to the original position (referring to FIG. 4).

In summary, the manufacturing cost of the mold structure 10 of the present invention is lower. After extruding by the extrusion tool, the thumb may move the movable element 40 downwards synchronously to take out the product. Therefore, the operation procedure of the operator is reduced and the working efficiency is improved.

The present invention are thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A mold structure of an extrusion tool for extruding and sealing a connector, the mold structure being capable of being inserted into a mold supporting seat for receiving a coaxial cable; the mold structure clamping the coaxial cable, comprising:
a seat installed with a hole for receiving a coaxial cable;
a chuck passing through the seat so that the chuck can move toward or leave away from the coaxial cable along an axial direction; a cavity of the chuck facing to the hole of the seat; and
a movable element installed at one side of the seat for control an extent of movement of the chuck moving toward the coaxial cable along an axial direction; thereby, the chuck moves toward or leave from the axial direction; and the coaxial cable being clamped and fixed by a sufficient force.

2. The mold structure of an extrusion tool for extruding and sealing a connector as claimed in claim 1, wherein the movable element has a shift flange to cause the chuck to move toward the coaxial cable along the axial direction.

3. The mold structure of an extrusion tool for extruding and sealing a connector as claimed in claim 1, wherein the chuck has a spring to cause the chuck to leave away from the coaxial cable along the axial direction.
